(19) United States
(12) Patent Application Publication
(10) Pub. No.: US 2026/0341586 A1
(43) Pub. Date: Oct. 29, 2026

(54) THREE-PHASE TRANSFORMER FOR AN ISOLATED VOLTAGE CONVERTER

(71) Applicant: VALEO ELECTRIFICATION, Cergy Pontoise (FR)

(72) Inventors: Wendell DA-CUNHA-ALVES, Cergy Pontoise (FR); Roger DENIOT, Cergy Pontoise (FR); Massourang DIALLO, Cergy Pontoise (FR); Julien LEVEQUE, Cergy Pontoise (FR); Baptiste PARIGOT, Cergy Pontoise (FR); Amaury ROUET, Cergy Pontoise (FR)

(73) Assignee: VALEO ELECTRIFICATION, Cergy Pontoise (FR)

(21) Appl. No.: 19/133,098

(22) PCT Filed: Nov. 28, 2023
(86) PCT No.: PCT/EP2023/083431

§ 371 Date: May 27, 2025

(30) Foreign Application Priority Data
Dec. 8, 2022 (FR) FR2212970

(51) Int. Cl. H01F 27/32; H01F 3/14; H01F 27/04; H01F 27/24; H01F 30/12

(52) U.S. Cl. CPC H01F 27/325; H01F 3/14; H01F 27/04; H01F 27/24; H01F 30/12

(57) ABSTRACT

A three-phase transformer for an isolated voltage converter includes a magnetic circuit, having a first part and a second part. Each part includes a base with a substantially triangular outline, and three pads each extending towards the base of the other part of the magnetic circuit. Also included three supports of electrical conductors, each support being mounted on two facing pads belonging to one and the other part, respectively, of the magnetic circuit, each support of electrical conductors carrying two electrical windings that are coupled inductively to one another via the magnetic circuit. Each pad of one part of the magnetic circuit defines at least one air gap other than via its cooperation with the pad of the other part of the magnetic circuit that it faces.

The present invention relates to a three-phase transformer for an isolated voltage converter, with such a voltage converter being integrated, for example, into a component for supplying electric power to a vehicle electrical energy storage unit, also called “charger” for this electrical energy storage unit. The electrical energy storage unit is, for example, a battery, which can have a nominal voltage that is greater than 60 V, for example, greater than or equal to 300 V, 400 V, 800 V, or even 1,000 V. The voltage converter receives, for example, an AC voltage from an electrical network and provides the battery with a DC voltage. This converter can convey a power that is greater than 5 kW, for example, greater than 7 kW, for example, greater than 11 kW, notably 22 kW or more. Such a converter comprises a three-phase transformer. The use of such a transformer can allow galvanic isolation and voltage matching to be achieved.

Three-phase transformers comprising three coils each formed by a winding around a fer-rite core or column arranged in the same plane in an aluminum casing are already known. This type of transformer has several disadvantages limiting its performance capabilities. These disadvantages include high inductance drops when the transformer is arranged in the aluminum casing, unbalanced currents, a non-uniform resonant frequency, and high losses in the aluminum casing.

Transformers are known from documents FR 3113178, DE 102018 206389 and JP 2019-079944 with multiple legs with a single air gap per leg supporting electrical windings.

A requirement exists for overcoming the aforementioned disadvantages.

The aim of the invention is to address this requirement, and this is achieved, according to one of the aspects thereof, using a three-phase transformer for an isolated voltage converter, comprising:
a magnetic circuit, comprising a first portion and a second portion, each portion comprising: a base with a substantially triangular outline, with this outline notably defining an equilateral triangle, and three pads each extending toward the base of the other portion of the magnetic circuit;
three supports for electrical conductors, with each support being mounted on two opposing pads respectively belonging to one and to the other of the portions of the magnetic circuit, each support for electrical conductors supporting two electrical windings inductively coupled with one another by means of the magnetic circuit;
characterized in that each pad of one portion of the magnetic circuit defines at least one air gap other than via its cooperation with the pad of the other portion of the magnetic circuit that it faces.

Thus, in the transformer according to the invention, for each phase, the magnetic field allowing inductive coupling passes through at least three air gaps. The use of additional resonant inductors for decoupling purposes is avoided. This results in a reduction in the bulk of the converter integrating the transformer.

The magnetic circuit can comprise a central leg supported by one of the portions of the magnetic circuit. This central leg can allow any iron losses in the magnetic circuit to be reduced.

The central leg can be made in one piece with the portion of the magnetic circuit supporting said leg.

The central leg can extend between two ends each in contact with one of the bases of the magnetic circuit. No air gap is then provided in the central leg. Due to the absence of an air gap in the central leg and the presence of the air gaps in the vicinity of the pads of the magnetic circuit, the phases of the transformer are decoupled and any inductance leaks are balanced.

The central leg can have a core and three protrusions extending from this core, each protrusion extending between two neighboring pads supported by the same portion of the magnetic circuit.

Each protrusion of the central leg can have a wall facing a pad whose shape is the same as that of the pad. This similarity in shape can promote the integration of these protrusions in the space between two neighboring pads.

The portion of each pad can extend from the base of the portion of the magnetic circuit that is made in one piece with this base of the portion of the magnetic circuit.

From one portion of the magnetic circuit to the other, the pads can extend toward the base of the other portion of the magnetic circuit over the same height. In other words, the height of the pads supported by a portion of the magnetic circuit from its base can be equal to the height of the pads supported by the other portion of the magnetic circuit from its base.

The magnetic field flowing between two electrical windings supported by the same support for electrical conductors can pass through exactly three air gaps. In other words, two pads respectively belonging to a portion of the magnetic circuit and facing each other can define a peripheral leg and this peripheral leg can have exactly three air gaps.

Each support for electrical conductors can comprise:
a wall around which the electrical windings are arranged, with this wall notably defining a hollow cylinder with a circular cross section; and
three edges offset along the longitudinal axis of the support, so that one of the electrical windings is arranged between the first and the second edge and so that the other one of the electrical windings is arranged between the second and the third edge.

The gap between two consecutive edges can be constant or varied.

In other words, the two electrical windings supported by a support for electrical conductors can follow one another along this support, without overlapping in planes perpendicular to the longitudinal axis of this support.

Each support for electrical conductors can integrate at least one of the following:
a guiding system for guiding at least one of the two electrical conductors outside the electrical winding that it defines;
a holding system for holding this support on the magnetic circuit;
a holding system for holding this support on a casing of the transformer, notably on a body of this casing; and
a holding system for holding a cover for the casing of the transformer on this support.

Such a support for electrical conductors integrating all or some of the aforementioned systems can be made in a single piece, for example, from a plastic such as polybutylene terephthalate (PBT), or polyamide (PA).

The aforementioned guidance system can comprise at least one clamp cooperating with one of the electrical conductors beyond an end of the electrical winding that it defines.

This guidance system can comprise two additional walls extending along the longitudinal axis of the support, with these two additional walls being offset and together defining a guidance channel receiving at least one of the electrical conductors outside the winding that it defines.

The aforementioned system for holding the support on the magnetic circuit can comprise at least one block projecting from the rest of the support. The block can define a surface coming into contact with a surface of a base of the magnetic circuit.

The aforementioned system for holding the support on the casing of the transformer can comprise at least one pin, notably a single pin, projecting from the rest of the support. The pin can have a cross-section perpendicular to the longitudinal axis of the support that is cruciform. The pin can be forcibly received in an opening provided in the casing, notably in the body of the casing, so as to ensure that the support is held on the casing.

The aforementioned system for holding the cover of the casing on the support can comprise at least one pin projecting from the rest of the support. The pin can have a cross-section perpendicular to the longitudinal axis of the support that is cruciform. The pin can be forcibly received in an opening provided in the cover of the casing, so as to ensure that the cover is held on the support.

The system for holding the cover of the casing on the support and the additional walls of the guidance system can project from the rest of the support on the same side of the support, along the longitudinal axis of this support.

The system for holding the cover of the casing on the support and the system for holding the support on the casing of the transformer can project from the rest of the support, from opposite sides of the support, along the longitudinal axis of the support.

In another variant, the cover is held on the body of the casing by means of screws received in holes provided in the wall of the body of the casing, notably in holes arranged in a shoulder of the wall of the body of the casing. Therefore, the cover is not held via the support for electrical conductors. The use of a metal cover with this screw fastening provides an EMC shield for the casing.

The magnetic circuit and the supports for electrical conductors are arranged, for example, in the casing, with said casing notably being filled with a resin that is then polymerized in order to immobilize the inside of the casing.

The three supports for electrical conductors can define a triangular pattern, notably an equilateral triangle.

A further aim of the invention, according to another aspect thereof, is a component for supplying electric power to a vehicle electrical energy storage unit, comprising the transformer defined above. The electrical energy storage unit is, for example, a battery that can have one of the above nominal voltages.

The invention will be better understood upon reading the following description of non-limiting embodiments thereof:

FIG. 1 schematically shows a portion of the electrical circuit of a component for supplying electric power to a vehicle electrical energy storage unit;

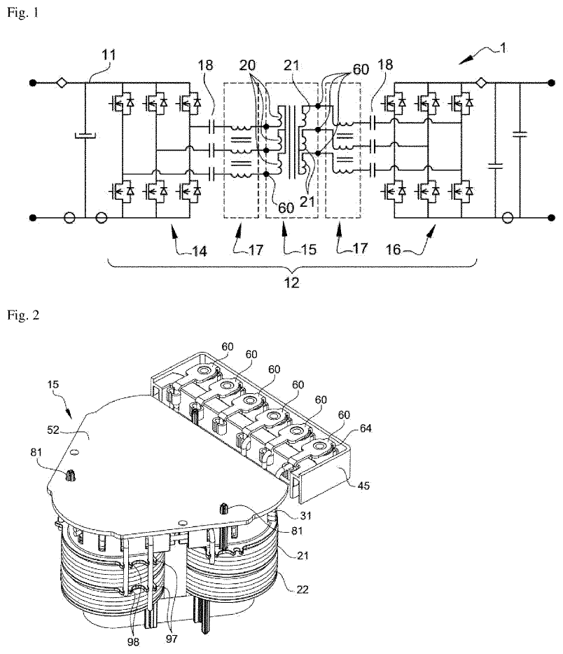

FIG. 2 shows an elevated view of an example of a three-phase transformer that can be used in the circuit of FIG. 1;

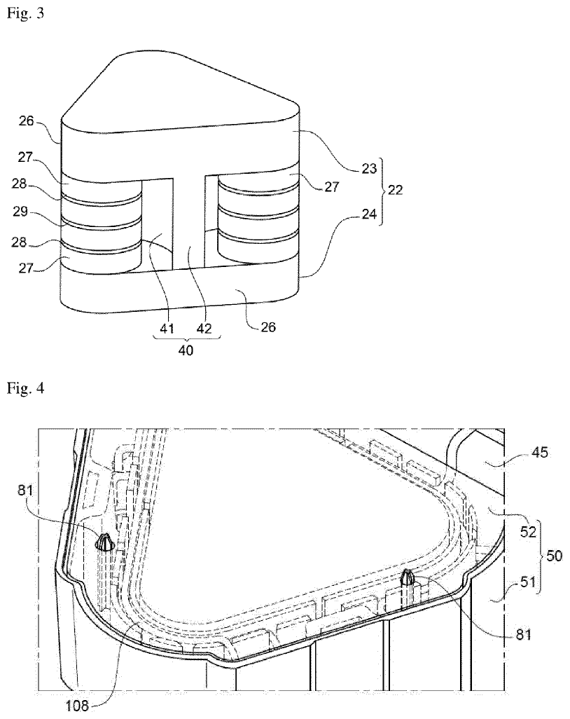

FIG. 3 shows an isolated view of the magnetic circuit of the three-phase transformer of FIG. 2;

FIG. 4 partially shows the three-phase transformer of FIGS. 2 and 3 when the cover of the casing is removed;

FIG. 5 shows a detailed view of an example of a system for holding the cover of the casing of the transformer on the support;

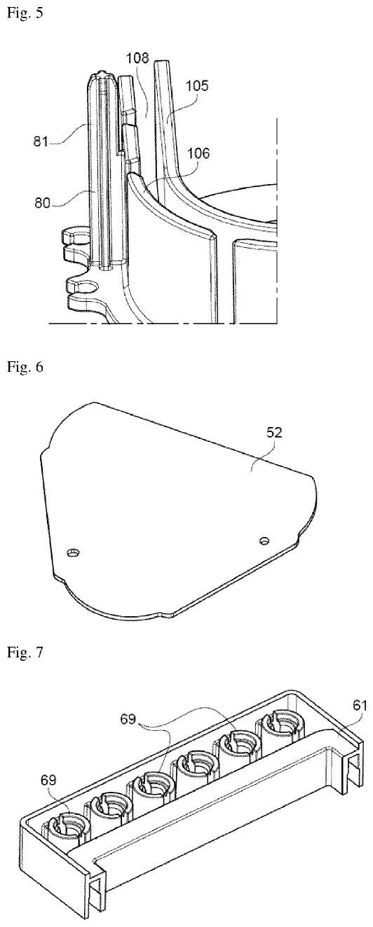

FIG. 6 shows the cover of the casing of FIG. 4;

FIG. 7 shows an isolated view of the body of the terminal block visible in FIG. 2;

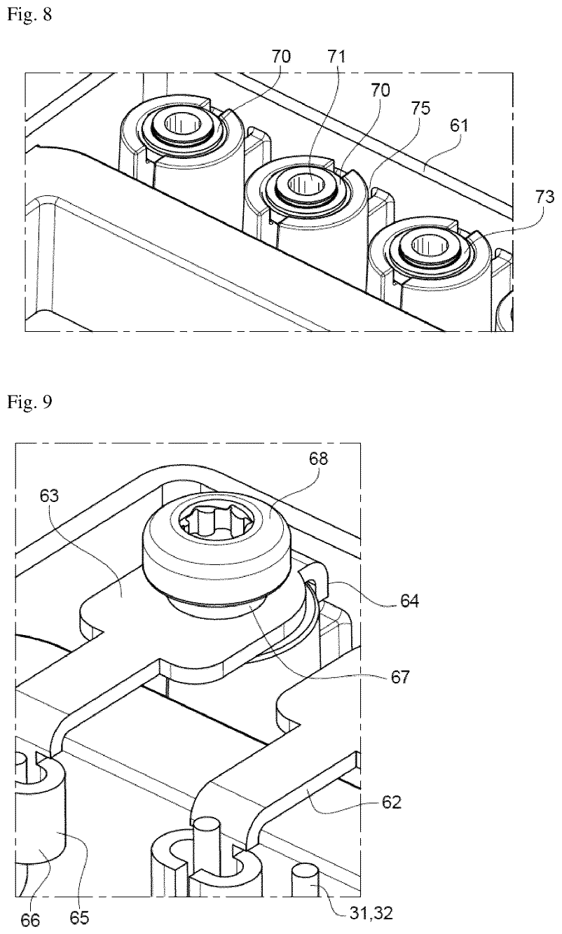

FIG. 8 shows the body of FIG. 7 in which inserts are arranged;

FIG. 9 shows the terminal block of FIGS. 7 and 8 with an electrically conductive bar and screw;

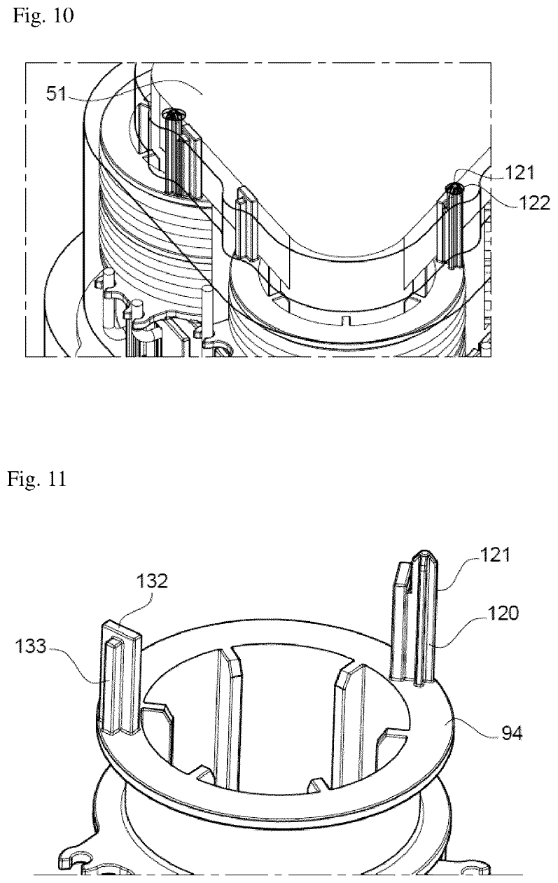

FIG. 10 shows the face of the transformer opposite that shown in FIG. 4;

FIG. 11 is a view of the support for electrical conductors of the transformer from the same side as FIG. 10 and shows the system for holding the support on the magnetic circuit and the system for holding the support on the body of the casing of the transformer borne by this support;

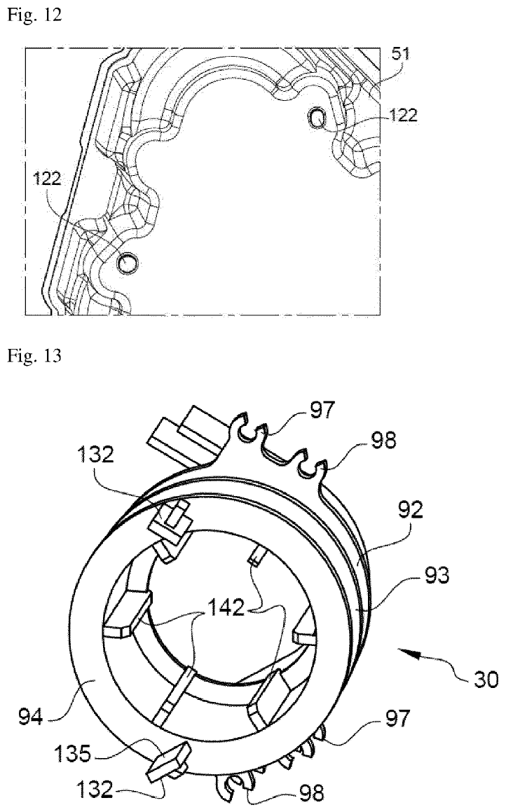

FIG. 12 shows the body of the casing of the transformer on which the support for electrical conductors of FIG. 11 is held;

FIG. 13 is a view similar to FIG. 11 and also shows ribs allowing this support to extend away from the portion of the magnetic circuit on which it is mounted;

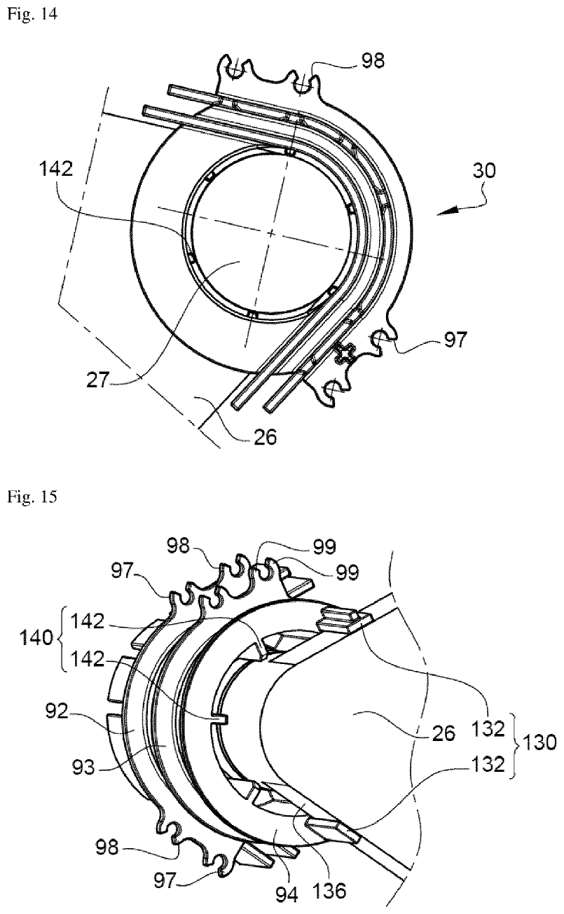

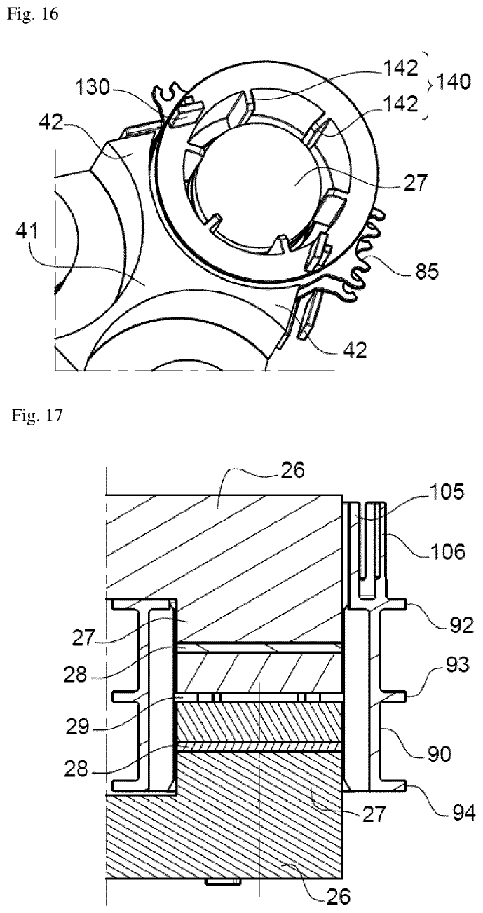

FIG. 14, FIG. 15 and FIG. 16 are views similar to that of FIG. 13 when the support for electrical conductors is mounted on the portion of the magnetic circuit;

FIG. 17 is a cross-sectional view of FIG. 16;

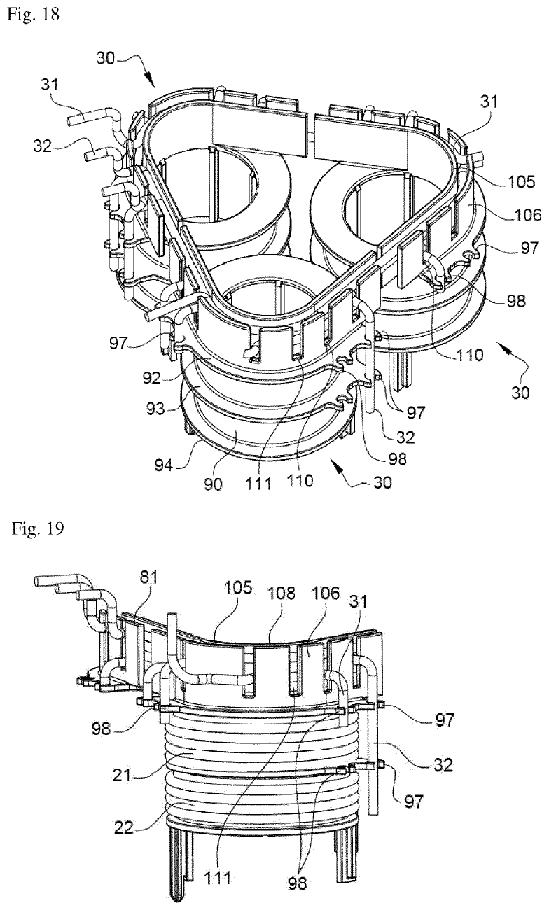

FIG. 18 shows three supports for electrical conductors of the transformer and their electrical conductors, without the magnetic circuit;

FIG. 19 shows an isolated view of one of the three supports for electrical conductors of FIG. 18 with its electrical conductors;

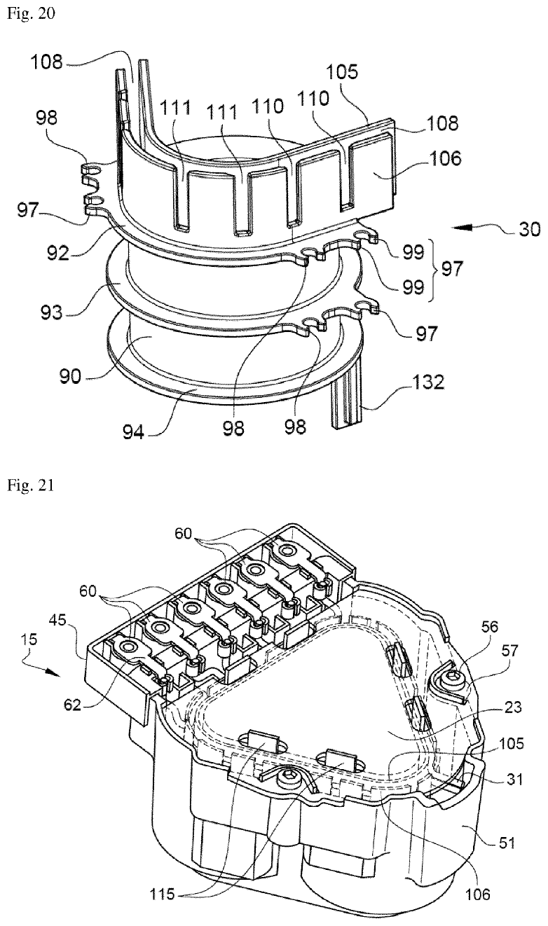

FIG. 20 shows the support for electrical conductors of FIG. 19 without its electrical conductors; and

FIG. 21 shows, in a similar way to FIG. 2, another example of a three-phase transformer that differs, among other things, by the way in which the cover is held.

FIG. 1 shows a portion of the electrical circuit 1 of a component for supplying electric power to a vehicle electrical energy storage unit. This component is also called “charger”. The electrical energy storage unit, not shown in FIG. 1, is, for example, a battery, which can have a nominal voltage that is greater than 60 V, for example, greater than or equal to 300 V, 400 V, 800 V, or even 1,000 V.

The circuit 10 receives an AC voltage as input from a network, not shown, which in this case is three-phase. A rectifier for converting this AC voltage into DC voltage, and also, where applicable, for fulfilling a power factor correction function, is arranged upstream of a DC bus 11. An insulated voltage converter 12, in this case a DC/DC converter, is arranged downstream of this DC bus, from the electrical network. This converter 12 comprises, in a known manner, an inverter 14, a three-phase transformer 15, and a rectifier 16 providing the vehicle with a DC voltage that is isolated from the electrical network. As can be seen in FIG. 1, the three-phase transformer 15 is connected to both the rectifier 16 and the inverter 14 by a block of inductors 17 and a block of capacitors 18, so as to define a CLLLC structure. Of course, other structures are possible, such as an LLC, CLLC, LC or even a CL structure.

As can be seen in FIG. 1, each phase has a primary winding 20 and a secondary winding 21 inductively coupled to one another, and the primary windings 20 are star-connected and the secondary windings 21 are also star-connected.

The three-phase transformer 15 comprises, in the considered example, a magnetic circuit 22 comprising a first portion 23 and a second portion 24. Each portion 23, 24 comprises: a base 26 with a substantially triangular outline, and three pads 27 each extending toward the base 26 of the other portion of the magnetic circuit 22. Each base 26 in this case has an outline defining an equilateral triangle.

The transformer 15 further comprises three supports 30 for electrical conductors 31, 32, with each support 30 in this case being mounted on two facing pads 27 respectively belonging to one and to the other of the portions 23, 24 of the magnetic circuit. Two electrical conductors 31, 32 linked to the same support 30 respectively have a portion defining a primary winding 20 and a portion defining a secondary winding 21. These electrical conductors 31, 32 are Litz wire, for example.

As can be seen in FIG. 2, the three supports 30 for electrical conductors 31, 32 are positioned so as to define an equilateral triangle.

The transformer 15 further comprises a casing 50 comprising a body 51 closed by a cover 52, which are visible in FIGS. 4 and 6. This body 51 and this cover 52 are, for example, made of metal, for example, of aluminum. The supports 30 and the magnetic circuit 22 are arranged inside the casing 50. The body 51 is filled with a resin that can be polymerized in order to harden and immobilize (“potting”) the components arranged inside the body.

As can be seen in FIGS. 4 and 6, the casing 50 also has a triangular outline, in this case more specifically being an equilateral triangle. The casing is, in the considered example, exclusively formed by the body 51 and the cover 52, but the invention is not limited to a casing 50 made up of two portions.

As can be seen in FIG. 3, each pad 27 defines a specific air gap 28, for example, via an area of the pad 27 filled with non-magnetic material, such as a composite of epoxy resin reinforced with glass fiber (FR4) or of ceramic. This area occupied by this non-magnetic material defines, for example, a whole slice of the pad. A plurality of sections is assembled, for example, with this area of the pad 27 in order to form this pad 27. As can be seen in FIG. 3, an additional air gap 29 is present between the facing ends of two pads 27 respectively belonging to different portions 23, 24 of the magnetic circuit 22. Thus, in the considered example of the magnetic circuit 22, each magnetic field allowing inductive coupling between a primary winding 20 and a secondary winding 21 crosses exactly three air gaps.

Still with reference to FIG. 3, it can be seen that the magnetic circuit 22 of the considered example comprises a central leg 40 supported by one of the portions 23, 24 of the magnetic circuit 22. This central leg 40 in this case is made in one piece with the portion 23 of the magnetic circuit 22 supporting said leg.

FIG. 3 shows that the central leg 40 continuously extends, in this example, between two ends, each being in contact with one of the bases 26 of the magnetic circuit 22, so that no air gap is provided in the central leg 40.

FIG. 3 or FIG. 16 also show that the central leg 40 has a core 41 and three protrusions 42 extending from this core 41, with each protrusion 42 extending between two neighboring pads 27 supported by the same portion of the magnetic circuit.

As can be seen in FIG. 3, in the considered example, each pad 27 has a circular exterior outline, and each protrusion 42 of the central leg 40 in this case has a rounded wall facing the pads 27.

As can be seen in FIG. 2, the three-phase transformer 15 comprises a connection terminal block 45. This connection terminal block 45 is attached to one side of the casing 50 of the three-phase transformer 15. As can be seen in FIG. 2, the terminal block 45 in this case defines six terminals 60 for connecting the three-phase transformer 15 to the rest of the electrical circuit 10, with these terminals 60 being schematically shown in FIG. 1. These terminals 60 in this case come into contact with electrical tracks of an electronic board, not shown.

As can be seen in FIG. 2, the connection terminal block 45 has an elongated shape, and the six terminals 60 are arranged in a row in this case.

The various elements of the terminal block 45 according to the embodiment shown will now be described with reference to FIGS. 7 to 9.

The terminal block 45 in this case comprises a body 61 and a plurality of electrically conductive bars 62, with each terminal 60 being defined by a portion 63 of a bar. Each portion 63 is flat in this case, so as to come into contact with an electrical track of the aforementioned electronic board. The body 61 can be made of plastic, for example, of PBT, PA, etc.

Each electrically conductive bar 62 has, for example, a portion 65, opposite the portion 63 defining the terminal, which is electrically connected to one of the electrical conductors 31, 32, in this case via a hollow sleeve 66, inside which the conductor 31, 32 is inserted, for example, attached by crimping or welding.

Each electrically conductive bar 62 locally comprises a hole 67 and this electrically conductive bar 62 is attached to the body 61 by means of a screw 68 received in this hole 67. The body 61 in this case comprises six housings 69, and each of these housings receives an insert 70 that houses a hole 71, with the aforementioned screw 68 being received in an insert hole 71. Thus, the electrically conductive bar 62 is attached to the body 61 via the screw 68 and the insert 70 is received in the housing 69. Each insert 70 can be made of metal, notably of steel. As a variant, each insert is made of composite material. Six inserts are provided, for example, and, in the considered example, all these inserts 70 have the same shape and the same dimensions. Each screw 68 can, in addition to ensuring the attachment of an electrically conductive bar 62 to the body 61, also ensure the attachment of the electrically conductive bar 62 to the electronic board, not shown.

As can be seen in FIG. 8, each insert 70 can define a positioning relief 73 for positioning the portion 63 of the electrically conductive bar defining the hole 67. This positioning relief 73 is, for example, a circular flat part.

As can be seen in FIGS. 2, 7 and 8, the exterior wall of each housing 69 can house a recess 75 able to accommodate an end portion 64 of the electrically conductive bar 62 in order to ensure correct positioning of this bar on the body 61 and to prevent any relative rotation between this bar and this body.

In another embodiment, not shown, the body 61 comprises a plurality of housings 69 that receive the screws 68 directly, in the absence of an insert 70. In this other embodiment, the electrically conductive bar 62 is attached to the body 61 directly via the screw 68, without an intermediate piece.

As can be seen in FIGS. 4 and 5, each support 30 for electrical conductors can integrate a holding system 80 for holding the cover 52 on this support 30.

Each support 30 comprises, for example, a single pin 81 projecting from the rest of the support 30 along the longitudinal axis of said support. As a variant, only two of the three supports of the transformer 15 comprise a pin 81, with the third support 30 being devoid of said pin.

FIG. 5 shows a pin 81 in detail, with said pin being able to have a section that is perpendicular to the longitudinal axis of the support that is cruciform. Each pin 81 of a support 30 for electrical conductors is, in the considered example, forcibly received into an opening provided in the cover 52, as can be seen in FIG. 4. The relative arrangement of the pins 81 of the supports 30 allows the cover 52 to be immobilized.

As can be seen in FIG. 5, the holding system 80 for holding the cover 52 on the support 30 can extend along the longitudinal axis of the support 30 on the same side of the support 30 as a guidance system 85 for guiding electrical conductors, which will be described with reference to FIGS. 18 to 20.

In FIGS. 18 to 20, the holding system 80 is not shown, the guidance system 85 can be present without the holding system 80 necessarily being present, other ways of holding the cover 52 are possible, as is notably described with reference to FIG. 21.

As can be seen in FIG. 18, each electrical conductor 31, 32 supported by a support 30 of the transformer 15 can be guided outside the winding 20, 21 that it defines.

In the considered example, each of these conductors 31, 32 is guided by the guidance system 85 beyond each of the ends of the electrical winding 20, 21 that it defines. As already mentioned above, and as can be seen in FIGS. 2 and 21, the first ends of the electrical conductors can form an output toward the electrical circuit 10 outside the transformer 15, and three of the second ends of the electrical conductors can lead toward a common point via a star connection to the primary, and three other ends of these second ends of the electrical conductors can lead toward a common point via another star connection to the secondary.

The support 30 for two electrical windings 31, 32 comprises:
a wall 90, around which the electrical windings 20, 21 are arranged, and this wall 90 defines, in the considered example but in a non-limiting manner, a hollow cylinder with a circular cross section; and
three edges 92, 93, 94 offset along the longitudinal axis of the support, so that one of the electrical windings 31 is arranged between the first 92 and the second 92 edge and so that the other one of the electrical windings 32 is arranged between the second 93 and the third 94 edge, as is clearly visible in FIG. 2, for example. The gap between two consecutive edges 92, 93 and 93, 94 remains constant in the considered example.

The guidance system 85 acts on the electrical conductors, on the one hand, via clips 97 and 98, and, on the other hand, via additional walls 105 and 106.

In the example of FIGS. 18 to 20, the guidance system 85 comprises, for each electrical conductor 31, 32, on the one hand, a first clip 97 cooperating with this electrical conductor 31, 32 beyond the first end of the electrical winding 20, 21 that it defines. Such a clip 97 has, for example, two curved arms 99 so as to fit closely with an area of the outline of this end of the electrical conductor, as shown in FIG. 18 or 20. A circular outline is involved in this case. Each clip 97 is, for example, but in a non-limiting manner, made in one piece with the rest of the support 30 for electrical conductors. As already explained, each first clip 97 cooperates, for example, with a portion of the electrical conductor 31, 32 on the way toward a connection terminal 60.

The guidance system 85 comprises, on the other hand, a second clip 98 cooperating with the electrical conductor beyond the second end of the electrical winding that it defines, with these first 97 and second 98 clips following one another along one of the first 92, second 93 and third 94 edges. As already explained, each second clip 98 cooperates, for example, with a portion of the electrical conductor 31, 32 on the way towards a common point of a star connection.

More specifically, in the considered example:
the first edge 92 comprises two first clips 97, which each respectively cooperate with one of the electrical conductors 31, 32 beyond the first end of the electrical winding 20, 21 that it defines, and two second clips 98, which each respectively cooperate with an electrical conductor beyond the second end of this electrical winding 20, 21; and
the second edge 93 comprises a first clip 97, arranged beneath a first clip 97 of the first edge 92, and a second clip 98, arranged beneath a second clip 98 of the first edge. The clips borne by the second edge 94 allow the electrical conductor 32 to be guided outside the electrical winding arranged between the second edge 93 and the third edge 94.

It can be seen in FIGS. 18 to 20 that two pairs of clips each formed by a first clip 97 and by a second clip 98 are found along the edge 92, and that the gap between two pairs of clips is greater than the distance between two clips of the same pair.

It also can be seen in these FIGS. 19 and 20 that the clips 97, 98 borne by the second edge 93 are aligned along the axis of the cylindrical wall 90 with clips 97, 98 borne by the first edge 92.

The two additional walls 105 and 106 of the guidance system 85 will now be described. These two additional walls 105 and 106 in this case are offset so as to together define a guidance channel 108 receiving, in a stacked manner, the electrical conductors 31, 32 outside the windings 20, 21 that they define. The channel 108 in this case has a constant dimension. These additional walls extend, in the considered example, on both sides of an arc-shaped portion of the first edge 92, axially projecting beyond this first edge 92. In the area overlapping with this first edge 92, the additional walls 105 and 106 each define an arc-shaped portion, with the wall 106 having a radius that is greater than the wall 105, as is also visible in FIG. 17.

It can be seen in FIGS. 18 to 20 that the wall 106 comprises first openings 110 for passing the electrical conductors 31, 32 toward the electrical winding 20, 21 that it defines, and second openings 111 through which no electrical winding passes. It can be seen that the first openings 110 are radially arranged facing a clip 97, 98.

In the example of FIGS. 10 to 12, each support 30 for electrical conductors 31, 32 also integrates a holding system 120 for holding onto the body 51 of the casing 50. This holding system 120 in this case comprises a pin 121 having, in this example, a section that is perpendicular to the longitudinal axis of the support and that is cruciform. This pin 121 axially extends away from the rest of the support 30 from the third edge 94. As can be seen in FIGS. 10 and 12, each pin 121 is forcibly received in an opening 122 provided in the body 51 of the casing 50. This holding system can ensure that the magnetic circuit 22 is immobilized on the body 51 of the casing before the resin contained in this casing 50 polymerizes.

When such holding systems 120 exist, they may or may not be combined with the aforementioned holding systems 80 and guidance systems 85. As can be seen in FIGS. 10 to 12, each holding system 120 can thus axially extend from one side of the support 30, while the holding system 80 and the guidance system 85 axially extend from the opposite side of the support 30.

A functionality that can be integrated into all or some of the supports 30 for electrical conductors 31, 32 will now be described with reference to FIGS. 13 to 15. A holding system 130 for holding the support 30 for electrical conductors 31, 32 on the magnetic circuit 22 is thus provided. This holding system 130 is in the form of two blocks 132 projecting from the rest of the support 30. When the holding system 120 is provided, these systems 130 and 120 can axially extend from the same side of the support, with the pin 121 and a block 132 notably being arranged side-by-side, as can be seen in the example of FIG. 11.

Each block 132 in this case defines a surface 135 coming into contact with a surface 136 of a base 26 of the magnetic circuit 22. The surfaces 135 and 136 are flat in this case. Each block 132 is supported, for example, by a reinforcement 133, as can be seen in FIG. 11.

As can be deduced from FIG. 15, the cooperation between the two blocks 132 of a support 30 and the base 26 can ensure that the support 30 is rotatably immobilized on the magnetic circuit 22.

Another functionality that can be integrated into all or some of the supports 30 of the electrical conductors 31, 32 will now be described with reference to FIGS. 13 to 16. It can be seen in these figures that the cylindrical wall 90 of the support 30 comprises ribs 142 extending away from the wall 90 toward the pad 27 on which this support is mounted.

In the considered example, six ribs 142 are provided, but the invention is not limited to a precise number of ribs 142. These six ribs 142 thus form a spacing system 140 for spacing the cylindrical wall 90, and therefore the electrical windings 20, 21 that it supports, apart from the pad 27.

It can be seen in FIGS. 13 to 16 that all the ribs 142 can assume the same shape and be uniformly distributed around the pad 27.

It also can be seen in these figures that each rib 142 can continuously extend along the axis of the support 30 from the first edge 92 up to the third edge 94.

In a variant, not shown, all or some of the ribs discontinuously extend along the axis of the support 30.

As can be seen in FIG. 16, each rib 142 does not extend, for example, up to the pad 27 on which the support 30 is mounted. An empty space ensuring easy mounting thus remains present between each end of a rib facing the pad 27 and this pad 27.

As already mentioned, each support 30 for electrical conductors 31, 32 can be made in one piece.

When this support 30 integrates:
the ribs 142; and/or
the holding system 80 for holding the cover 52 on the support; and/or
the guidance system 85 for guiding electrical conductors; and/or
the holding system 120 for holding the support on the body 51 of the casing; and/or
the holding system 130 for holding the support on the magnetic circuit 22;
all these systems may or may not be made in one piece with the rest of the support 30. In a particular example, the support 30 is thus in one piece and has all or some of the aforementioned functionalities.

The invention is not limited to the examples that have been described above.

In the example of FIG. 21, the cover 52 is held directly on the body 51 of the casing 50 by means of screws 56 received in a shoulder 57 of the wall of the body 51. The cover 52, which is clearly shown in FIG. 21, can seal the body 51, thus providing an EMC shield for the casing 50.

It can be seen in FIG. 21 that the wall 105 of the guidance system 85 can have additional projections 115 received in openings provided in the cover 52. These additional projections 115 define, for example, two slots per side of the transformer 15, and they can facilitate the introduction of the magnetic circuit 22, provided with supports 30, into the body 51 of the casing 50.

1. A three-phase transformer for an isolated voltage converter, comprising:
a magnetic circuit, comprising a first portion and a second portion, each portion comprising: a base with a substantially triangular outline, with this outline notably defining an equilateral triangle, and three pads each extending toward the base of the other portion of the magnetic circuit;
three supports for electrical conductors, with each support being mounted on two opposing pads respectively belonging to one and to the other of the portions of the magnetic circuit, each support for electrical conductors supporting two electrical windings inductively coupled with one another by means of the magnetic circuit, the three supports notably defining a triangular pattern, notably an equilateral triangle;
wherein each pad of one portion of the magnetic circuit defines at least one air gap other than via its cooperation with the pad of the other portion of the magnetic circuit that it faces.

2. The transformer as claimed in claim 1, the magnetic circuit comprising a central leg supported by one of the portions of the magnetic circuit.

3. The transformer as claimed in claim 2, the central leg being made in one piece with the portion of the magnetic circuit supporting said leg.

4. The transformer as claimed in claim 2, the central leg extending between two ends each in contact with one of the bases of the magnetic circuit, the central leg notably being devoid of an air gap.

5. The transformer as claimed in claim 2, the central leg having a core and three protrusions extending from this core, each protrusion extending between two neighboring pads supported by the same portion of the magnetic circuit.

6. The transformer as claimed in claim 5, each protrusion having a wall facing a pad whose shape is the same as that of the pad.

7. The transformer as claimed in claim 1, the magnetic field circulating between two electrical windings supported by the same support for electrical conductors passing through exactly three air gaps.

8. The transformer as claimed in claim 1, each support for electrical conductors integrating at least one of the following:
a guiding system for guiding at least one of the two electrical conductors outside the electrical winding that it defines;
a holding system for holding on the magnetic circuit;
a holding system for holding on a casing of the transformer; and
a holding system for holding a cover for the casing of the transformer.

9. The transformer as claimed in claim 1, each support for electrical conductors being made in one piece.

10. The transformer as claimed in claim 1, with the portion of each pad extending from the base of the portion of the magnetic circuit that is made in one piece with this base of the portion of the magnetic circuit.

11. The transformer as claimed in claim 1, with, from one portion of the magnetic circuit to the other, the pads extending toward the base of the other portion of the magnetic circuit over the same height.

12. The transformer as claimed in claim 1, the two electrical windings supported by the support for electrical conductors following one another along this support, without overlapping in planes perpendicular to the longitudinal axis of this support.

13. The transformer as claimed in claim 1, comprising a casing comprising a body and a cover, the magnetic circuit and the supports for electrical conductors being arranged in this casing, the cover being held on the body by means of screws received in holes provided in the wall of the body.

14. A component for supplying electric power to a vehicle electrical energy storage unit, comprising the transformer as claimed in claim 1.

15. The transformer as claimed in claim 3, the central leg extending between two ends each in contact with one of the bases of the magnetic circuit, the central leg notably being devoid of an air gap.

16. The transformer as claimed in claim 3, the central leg having a core and three protrusions extending from this core, each protrusion extending between two neighboring pads supported by the same portion of the magnetic circuit.

17. The transformer as claimed in claim 2, the magnetic field circulating between two electrical windings supported by the same support for electrical conductors passing through exactly three air gaps.

18. The transformer as claimed in claim 2, each support for electrical conductors integrating at least one of the following:
a guiding system for guiding at least one of the two electrical conductors outside the electrical winding that it defines;
a holding system for holding on the magnetic circuit;
a holding system for holding on a casing of the transformer; and
a holding system for holding a cover for the casing of the transformer.

19. The transformer as claimed in claim 2, each support for electrical conductors being made in one piece.

20. The transformer as claimed in claim 2, with the portion of each pad extending from the base of the portion of the magnetic circuit that is made in one piece with this base of the portion of the magnetic circuit.
